(19) United States
(12) Patent Application Publication
(10) Pub. No.: US 2013/0269230 A1
(43) Pub. Date: Oct. 17, 2013

(54) Triage Number System And Kit For Identifying Patients

(71) Applicants: Jonathan Robert Pinto, Round Rock, TX (US); Christopher Andrew Pinto, Round Rock, TX (US)

(72) Inventors: Jonathan Robert Pinto, Round Rock, TX (US); Christopher Andrew Pinto, Round Rock, TX (US)

(21) Appl. No.: 13/444,721

(22) Filed: Apr. 11, 2012

(51) Int. Cl. G09F 3/08

(52) U.S. Cl. 40/633

(57) ABSTRACT

The present invention relates to a patient identification system (device), and more particularly to a triage number system that includes a plurality of large Arabic numeric figures made of reflective material and/or plastic material so that when they are attached to patients via wrist band or zip-tie, the identification won't be washed off or smeared and is visible in the dark. The triage identification numbers further comprise a plastic pouch attached to the numeric figures for holding START triage tags and patients' personal belongs. The present invention further provides a kit including triage number system of the present invention for identifying patients, a clipboard with a pad of paper for organization, triage tags, zip-ties, and a triage vest or similar item in an easy to store trauma type bag.

### BACKGROUND OF THE INVENTION

1. Field of the Invention

The present invention relates to a patient identification system (device), and more particularly to a triage number system that includes a plurality of large Arabic numeric figures made of reflective material and/or plastic material so that when they are attached to patients via wrist band or zip-tie, the identification won't be washed off or smeared and is visible in the dark.

2. Description of Related Art

Originally, triage was a process performed by a nurse or other medical professional personnel during wartime or a mass casualty incident caused by nature, or man-made, to determine the priority of patients' treatments based on the severity of their condition and group them into one of three or four categories: those too ill to benefit from immediate medical care, those well enough to survive without immediate care, and those who could benefit from immediate care and have more severe injuries or milder injuries. In situations in which immediate medical care was a scare resource, triage methodology helped ensure that such care would be allocated rationally, for maximum aggregate benefit.

In a broader sense, triage system exists to ensure that an appropriate level of care is dispensed to all individuals, by evaluating the significance of the patients' symptoms and matching them with a particular level of care.

Nevertheless, when there are natural disasters or trauma incidents (e.g. earthquake) with multiple patients, it is very difficult for the First Responders to methodically label each patient, in order to be able to quickly identify the patients by other paramedical or medical staff when they arrive on the scene of the incident. Since there are generally many ambulances, hospitals, EMTs and paramedics involved, it is very important that the paramedical and medical staff recognize which patient is which and which hospital the patient should be transported to.

Currently in many jurisdictions the patient labeling/identification is done by using some sort of “permanent black marker” and actually drawing a number on the patient's forehead or arm; the mark can be washed off in the rain or get too smeared or dirty to recognize. If it is dark outside, and if there are many patients, it is hard to see who is who and which number is marked on the patient.

Accordingly, there exists a need to have a device (or system) for patient's labeling/identification that won't be washed off or smeared in the rain and is visible in the dark.

### SUMMARY OF THE INVENTION

The triage number system for patient labeling/identification according to the present invention comprises a plurality of numeric figures which are made of plastic material, reflective material, and/or the combination thereof. The numeric figures are made into large Arabic numbers from 0 to 9 so that they can be used up to 99 patients. Other materials suitable for the intended purpose of numeric figures may be used in another embodiment. Each numeric figure has a plurality of holes. The numeric figure is attached to a part of patient's limbs through a hole by a wrist band and/or a zip-tie; thus making patients' identification much easier for First Responders, EMT, Paramedic Staff in ambulances, and Medical Staff. The numeric figures may be connected through the holes on the figure via zip-tie so that the triage number system (from number 0 to 9) may be used up to 99 patients. This system may be less expensive, more practical, and needs less space to store. In another embodiment, the triage number system may include 2-digit numeric figures so that there is no need to connect two 1-digit numeric figures together to represent patient number larger than 9. This system saves time but may be more expensive, needs more space to store. The wristbands and zip-ties may be any of commercial ones or of any ones known in the art.

By tagging the patients with a number, it allows rapid transport and treatment. The “Triage Officer” is able to give a specific patient identification number to the ambulance and to the hospital so that the ambulance can pick up and transport the exact patient to the hospital where the medical staff is standing by with the necessary preparation and is ready to go. Any information related to the patient of this patient number can be communicated at the same time. Thus, the patient can be recognized immediately and receive immediate medical treatment.

The triage number further comprises a plastic pouch for holding a START (Simple Triage and Rapid Transport/or Treatment) tag that indicates the category of the patient based on the severity of their injuries. The typical four categories are: Deceased, Immediate, Delayed and Minor. The plastic pouch which is attached or permanently affixed to the front of the numeric figure can also be used to store limited belongings such as a ring or watch that may have been broken or was found next to the patient at the incident site. The plastic pouch may also be a part of numeric figure that is made from a plastic mold. The plastic pouch has a cover with fastening means over the opening to prevent the START tags or personal belongs from getting wet or lost.

The numeric figures may be made of plastic material in a broad definition. In order to be visible in the dark, the triage numeric figures may be made of reflective material and/or the combination of plastic material and reflective material. Other material suitable for the intended purpose may be used to make triage numeric figures.

This triage number system is essential for recognition of patients, when there are traffic accidents that have many victims, natural disasters (earthquake, flood, and tsunami, etc.), fire, and other incidents. It can also be very useful when categorizing victims of road side bombs in the military. Every fire truck, military vehicle, police car, commercial jet, school buses and ambulance should carry this triage number system.

The present invention further provides a kit encased in an easy to store trauma bag including a triage number system (a plurality of numeric figures with plastic pouch and wristbands/zip-ties), a clipboard with a pad of paper and pens for organization, START triage tags, extra zip-ties or wristbands and a triage vest or the like. The kit having necessary triage items in one place helps to speed up the triage process so that the patients can receive immediate medical treatment once they are picked up and transported to the medical facilities.

The more important features of the invention have thus been outlined in order that the more detailed description that follows may be better understood and in order that the present contribution to the art may be appreciated better. Additional features of the invention will be described hereinafter and will form the subject matter of the claims that follow.

Before explaining at least one embodiment of the invention in detail, it is to be understood that the invention is not limited in its application to the details of construction and the arrangements of the components set forth in the following description or illustrated in the drawings. The invention is capable of other embodiments and of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

The foregoing has outlined, rather broadly, the preferred feature of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention and that such other structures do not depart from the spirit and scope of the invention in its broadest form.

### BRIEF DESCRIPTION OF THE DRAWINGS

Other aspects, features, and advantages of the present invention will become more fully apparent from the following detailed description, the appended claim, and the accompanying drawings in which similar elements are given similar reference numerals.

FIG. 1 is a front view of a triage numeric figure of a single digit number.

FIG. 2 is a front view of a triage numeric figure of a double digits number.

FIG. 3 shows a front view of additional triage numeric figures.

### DESCRIPTION OF THE PREFERRED EMBODIMENT

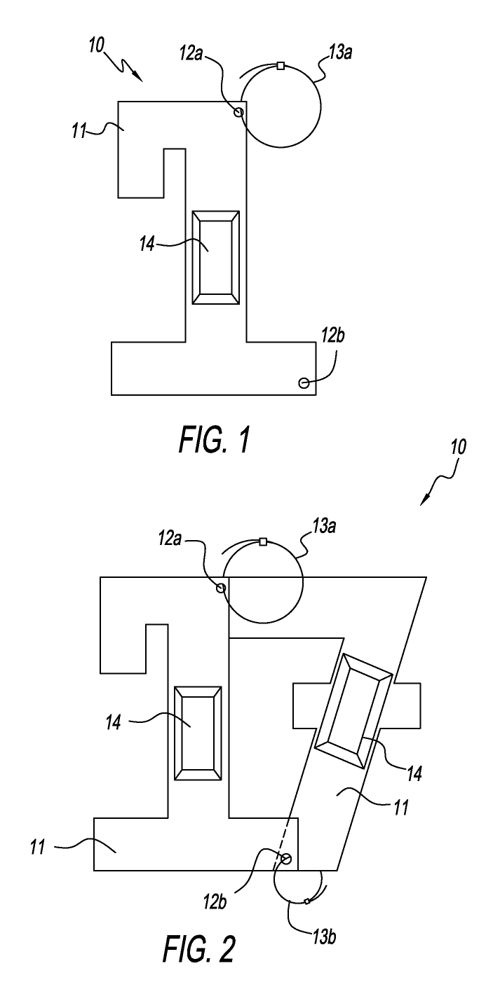

Referring to FIG. 1, there is disclosed a triage number 10 for patient identification used during a natural disaster or trauma incidents. The triage number 10 comprises a numeric figure 11 made in the shape of Arabic numbers from zero (0) to nine (9); a plurality of holes 12a and 12b on the numeric figure; a plurality of zip-ties 13a and 13b; and a plastic pouch 14 which is attached to the front of numeric figure for storing triage tag and/or personal belongings. The pouch has a cover with fastening means (not shown) to prevent the contents (START triage tags and personal belongs) from getting wet in the rain or getting lost. The wristband and/or first zip-tie 13a is used to attach the numeric figure 11 through the first hole 12a to the patient for identification purpose. The second zip-tie 13b is used to attach one numeric figure 11 with another numeric figure 11 through the second hole 12b to make a 2-digits number (number 10 and larger) when necessary.

FIG. 2 shows a triage number 10 of a 2-digits number where two pieces of numeric figures 11 are connected by the second zip-tie 13b via the second hole 12b on each piece of numeric figure 11.

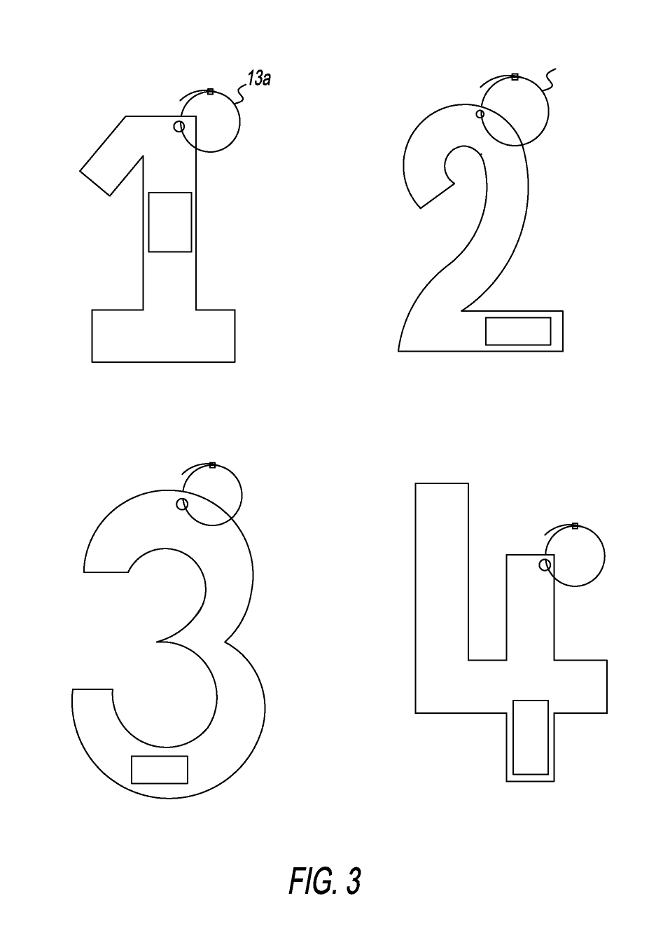

FIG. 3 shows designs of additional triage identification numbers.

While there have been shown and described and pointed out the fundamental novel features of the invention as applied to the preferred embodiments, it will be understood that the foregoing is considered as illustrative only of the principles of the invention and not intended to be exhaustive or to limit the invention to the precise forms disclosed. Obvious modifications or variations are possible in light of the above teachings. The embodiments discussed were chosen and described to provide the best illustration of the principles of the invention and its practical application to enable one of ordinary skill in the art to utilize the invention in various embodiments and with various modifications as are suited to the particular use contemplated All such modifications and variations are within the scope of the invention as determined by the appended claims when interpreted in accordance with the breadth to which they are entitled.

What is claimed is:

1. A triage number system for patient identification comprising:
(a) a plurality of numeric figures in a shape of Arabic numbers with a plurality of holes on each piece of numeric figure, one of the holes for attaching the numeric figure to the patient, one of the holes for attaching to another numeric figure if necessary;
(b) a plurality of wristbands or zip-ties for attaching the numeric figure to the patients through the holes on the numeric figure;
(c) a plurality of zip-ties for attaching the numeric figure to another numeric figure if necessary; and
(d) at least one pouch attached to the numeric figure for holding START triage tags and patient's personal belongings.

2. The triage number system of claim 1, wherein the Arabic numbers are from zero (0) through nine (9).

3. The triage number system of claim 1, wherein the numeric figure is made of one of the plastic material, reflective material, and the combination thereof.

4. The triage number system of claim 1, wherein the pouch made of plastic having cover with fastening means to prevent the contents (triage tags and personal belongings) from getting wet or getting lost.

5. A triage number system for patient identification comprising a plurality of numeric figures in a shape of Arabic numbers, each numeric figure has a plurality of holes, and at least one pouch for holding START triage tags and patient's personal belongings.

6. The triage number system of claim 5 further comprises zip-ties and wristbands for attaching the numeric figure to the patients through the holes on the numeric figure.

7. The triage number system of claim 5 further comprises zip-ties for attaching the numeric figure to another numeric figure if necessary.

8. The triage number system of claim 5, wherein the numeric figure is made of one of the plastic material, reflective material, and the combination thereof.

9. The triage number system of claim 5, wherein the pouch made of plastic having cover with fastening means to prevent the contents (triage tags and personal belongings) from getting wet or getting lost.

10. A triage kit for patient identification comprising:
(a) a plurality of numeric figures in a shape of Arabic numbers with a plurality of holes on each piece of numeric figure, one of the holes for attaching the numeric figure to the patient, one of the holes for attaching to another numeric figure if necessary;
(b) a plurality of wristbands or zip-ties for attaching the numeric figure to the patients through the holes on the numeric figure;
(c) a plurality of zip-ties for attaching the numeric figure to another numeric figure if necessary;
(d) at least one pouch attached to the numeric figure for holding START triage tags and patient's personal belongings.
(e) a plurality of START triage tags;
(f) a clipboard with a pad of paper and pens for organization; and
(g) triage vests.

11. The triage kit of claim 10, wherein the numeric figure is made of one of the plastic material, reflective material, and the combination thereof.

12. The triage kit of claim 10, wherein the pouch made of plastic having cover with fastening means to prevent the contents (triage tags and personal belongings) from getting wet or getting lost.
